(19) United States
(12) Patent Application Publication
(10) Pub. No.: US 2006/0143460 A1
(43) Pub. Date: Jun. 29, 2006

(54) Household terminal device and method and program for updating it

(75) Inventors: Hiroyuki Chaki, Ome-shi (JP); Takashi Kokubo, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/249,360

(22) Filed: Oct. 14, 2005

(30) Foreign Application Priority Data
Dec. 24, 2004 (JP) 2004-373477

(51) Int. Cl. H04L 9/00

(52) U.S. Cl. 713/176

(57) ABSTRACT

A household terminal device updating method comprises a first transmission step for, in updating copy protection canceling CERT information provided from a networked external server, transmitting an authentication command added with CERT information already stored, a first reception step for receiving updated signature information encrypted using a first shared key from the server, a second transmission step for transmitting an authentication command added with the updated signature information, a second reception step for receiving information of updating completion encrypted with a second shared key from the server, a decision step for decrypting the information using the second shared key and then making a decision of whether or not updating has resulted in success depending on whether or not the information of updating completion has been decrypted successfully, and an update step for duly updating the CERT information when the decision is that updating has resulted in success.

### CROSS-REFERENCE TO RELATED APPLICATIONS

This application is based upon and claims the benefit of priority from prior Japanese Patent Application No. 2004-373477, filed Dec. 24, 2004, the entire contents of which are incorporated herein by reference.

### BACKGROUND OF THE INVENTION

1. Field of the Invention

The present invention relates to a household terminal device suited for various digital household appliances and a method and program for updating the household terminal device.

2. Description of the Related Art

Conventionally, to safely obtain a license key for purchasing and playing back software or contents from a server, a technique has been devised which involves storing a shared key which is associated with software user's identification information related to payment of software charges under guarantee and is shared by a software provider and the user, requesting the software provider to provide specified software, and decrypting the specified software in encrypted form from the provider using the stored shared key (see, for example, Japanese Unexamined Patent Publication No. 09-244886).

However, the technique described in the above Patent Publication is adapted to decrypt encrypted software at the time of purchasing it and then make it available in a closed environment. The technique makes no assumptions about situations in which the way to form the shared key is changed to provide for improvements in the version of the software and information for identifying the new way or individual information for use is updated.

### BRIEF SUMMARY OF THE INVENTION

According to the present invention, there is provided a household terminal device comprising: first transmission means for, in updating signature information unique to the device which is used to cancel copy protection and provided from a networked external server, transmitting an authentication command added with the signature information already stored in order to share a first shared key with the server; first reception means for receiving updated signature information encrypted using the first shared key which is transmitted from the server in response to the authentication command transmitted by the first transmission means; second transmission means for transmitting an authentication command added with the updated signature information received by the first reception means in order to share a second shared key with the server; second reception means for receiving information of updating completion encrypted with the second shared key which is transmitted from the server in response to the authentication command transmitted by the second transmission means; decision means for decrypting the information received by the second reception means using the second shared key and then making a decision of whether or not updating has resulted in success depending on whether or not the information of updating completion has been decrypted successfully; and update means for updating the signature information when the decision by the decision means is that updating has resulted in success.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the overall configuration of a system according to an embodiment of the present invention;

FIG. 2 is a block diagram of a DVD recorder used as a terminal device in the system of FIG. 1;

FIG. 3 is a block diagram of the proxy server in the system of FIG. 1;

FIG. 4 is a block diagram of the management server in the system of FIG. 1;

FIG. 5 shows the flow of processes among the devices in the system of FIG. 1 at the time of updating CERT information;

FIG. 6 is a flowchart illustrating the processing of updating CERT information in the DVD recorder in the system of FIG. 1;

FIG. 7 is a flowchart illustrating the processing by the proxy server in the system of FIG. 1; and

FIG. 8 is a flowchart illustrating the processing by the management server in the system of FIG. 1.

### DETAILED DESCRIPTION OF THE INVENTION

An embodiment of the invention will be described hereinafter with reference to the accompanying drawings. The embodiment is directed to a DVD (Digital Versatile Disk) recorder having a built-in HDD (Hard Disk Drive) as a household digital electrical appliance and a system for updating that recorder.

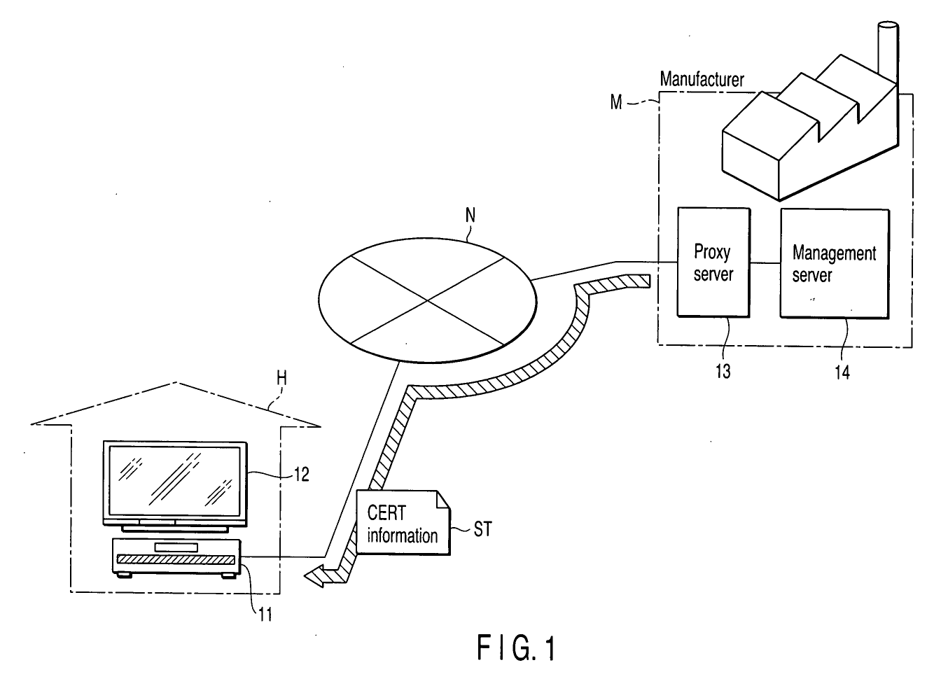

FIG. 1 shows the overall configuration of a system. In this system, reference numeral 11 denotes a DVD recorder which is a subject of updating. The DVD recorder 11 is placed and used in a house H together with a television monitor 12.

The DVD recorder 11 makes direct communication with a proxy server 13, which is operated by the recorder's manufacturer M, over an network N (e.g., the Internet) and is connected to a management server 14 as well via the proxy server. Thereby, the DVD recorder undergoes updating of CERT (Computer Emergency Response Team) information ST issued by the management server 14.

The CERT information ST, which is signature data unique to the DVD recorder 11 as a terminal device, provides a device signature that contains a unique device ID and version information.

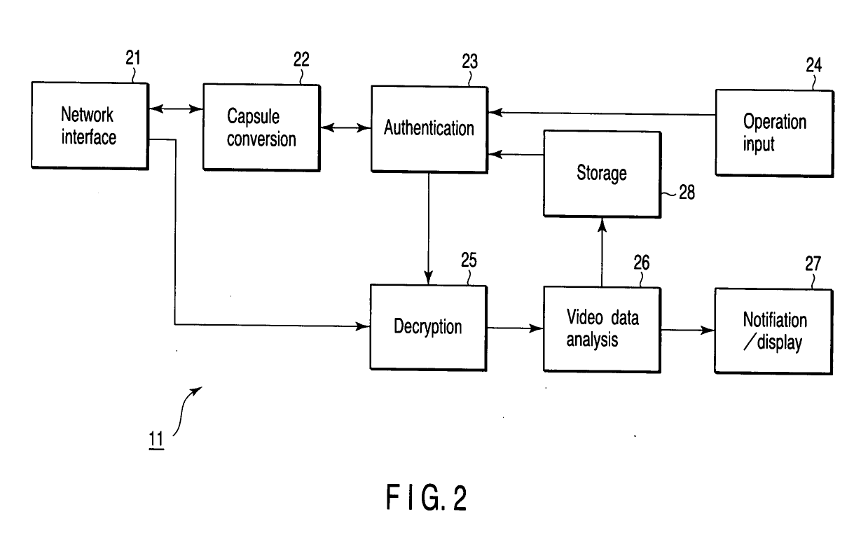

Referring now to FIG. 2 there is shown in block diagram form the configuration of the DVD recorder 11 for updating the CERT information ST. The DVD recorder 11 includes a network interface 21, a capsule conversion unit 22, an authentication unit 23, an operation input unit 24, a decrypting unit 25, a video data analysis unit 26, a notification/display unit 27, and a storage unit 28.

The network interface 21 uses TCP/IP (Transmission Control Protocol/Internet Protocol) to allow the DVD recorder 11 to make communication with the proxy server 13 over the network N.

The capsule conversion unit 22 converts data packets to be sent to the proxy server 13 into capsule form.

The authentication unit 23, when the DVD recorder 11 is connected to the management server 14 through the proxy server 13, performs device authentication processing.

The operation input unit 24, which is composed of keys arranged on the DVD recorder 11 and a remote controller not shown, accepts key operations from the user of the DVD recorder 11 when necessary.

The decrypting unit 25 decrypts CERT information ST and so on sent from the management server 14 using the shared key.

The video data analysis unit 26 separates various pieces of information superimposed on a video signal sent from the management server 14, sends the video signal to the notification/display unit 27, and outputs the separated download data, such as CERT information ST, to the storage unit 28.

The notification/display unit 27 receives the video signal from the video data analysis unit 26 and outputs it to the television monitor 12.

The storage unit 28 stores the download data separated in the video data analysis unit 26 and provides it to the authentication unit 23 when necessary.

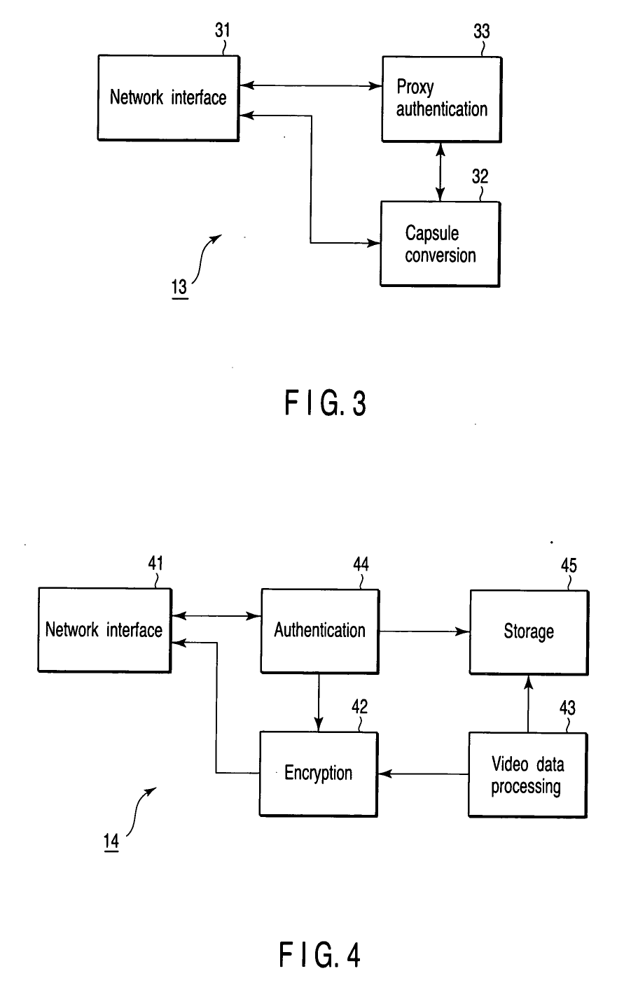

FIG. 3 is a block diagram of the proxy server 13. The proxy server 13 has a network interface 31, a capsule conversion unit 32, and a proxy authentication unit 33.

The network interface 31 performs control of communication between the management server 14 and the DVD recorder 11 through the use of TCP/IP.

The capsule conversion unit 32 adds header information and so on to data from the proxy authentication unit 33 to convert data to be sent to the DVD recorder 11 into capsule form.

The proxy authentication unit 33 extracts payloads from data received from the DVD recorder 11 and sends them to the management server 14. The proxy authentication unit also sends responses from the management server 14 to the capsule conversion unit 32.

FIG. 4 is a block diagram of the management server 14. The management server 14 has a network interface 41, an encryption unit 42, a video data processing unit 43, an authentication unit 44, and a storage unit 45.

The network interface 41 performs control of communication with the proxy server 13.

The encryption processing unit 42 encrypts data to be sent to the DVD recorder 11.

The video data processing unit 43 performs a process of multiplexing video data and download data which are to be sent to the DVD recorder 11.

The authentication unit 44 carries out an authentication process on the DVD recorder 11 in which CERT information ST is to be updated.

The storage unit 45 stores CERT information for various terminal devices including the DVD recorder 11 as differential information between new and old versions of each CERT information in the form of a database. In addition, the storage unit 45 stores video data which is displayed at the time of updating CERT information and video data which is displayed when CERT information has been successfully updated.

The operation of the embodiment described above will be described next.

The operation of the embodiment is described on the premise that DTCP (Digital Transmission Copy Protection) is performed as copy protection. DTCP's contents shall be limited to updating of CERT information ST issued from the DTLA (Digital Transmission Licensing Administrator).

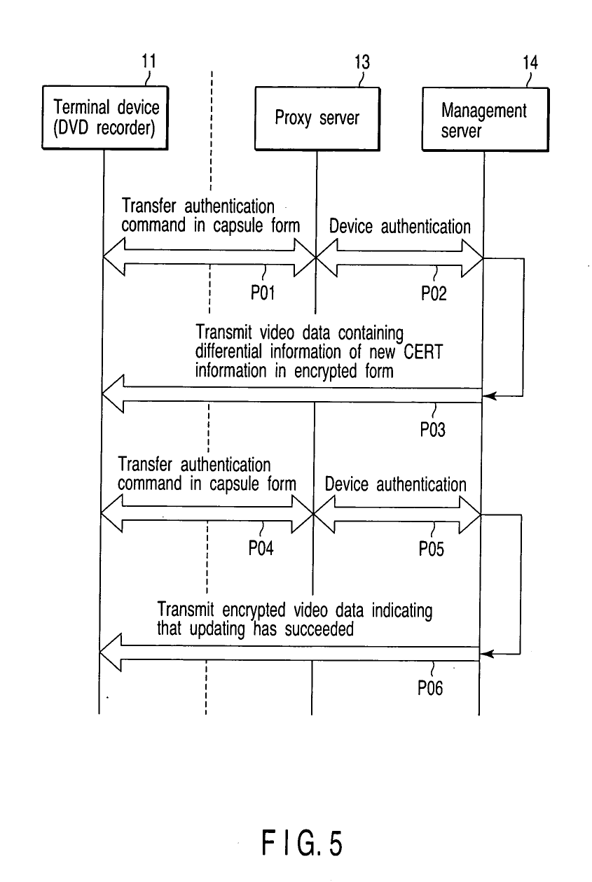

FIG. 5 shows the flow of processes among the DVD recorder 11, the proxy server 13, and the management server 14.

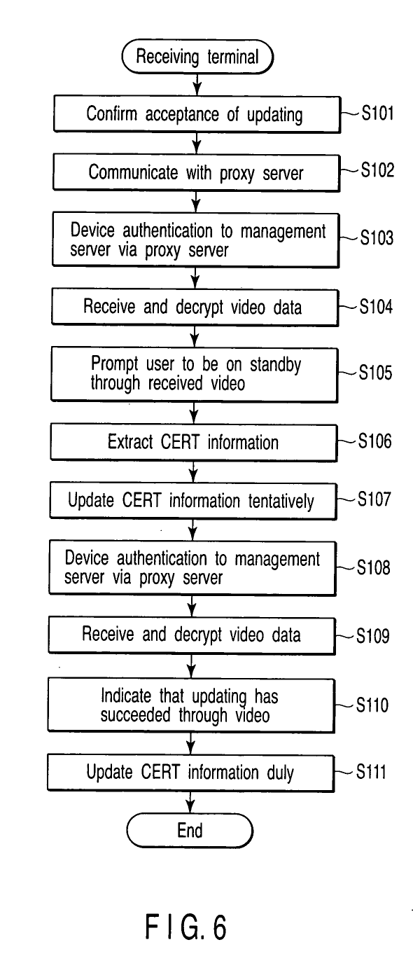

The operations of the respective devices, i.e., the DVD recorder 11, the proxy server 13 and the management server 14, will be described with reference to FIGS. 6, 7, and 8, respectively.

In expanding the function of a new application program through downloading over the network N, the DVD recorder 11 starts updating of CERT information ST as needed.

In this case, the DVD recorder 11 displays guide messages on the screen of the television monitor 12 using the notification/display unit 27 to notify the user that CERT information ST is to be updated and the updating will take some time. The DVD recorder confirms that the user performs a key operation to approve the updating on the operation input unit 24 (step S101) and then starts processing.

If, in this case, many terminal devices including the DVD recorder 11 started the updating process simultaneously, a heavy load would be imposed upon the management server 14 in the manufacturer M. It is therefore desired that the load on the management server 14 be lightened by scattering the updating start times of the respective terminal devices. To this end, the terminal devices may be started in sequence in descending order of device IDs, in other words, starting with the device with the newest device ID. Alternatively, a random number may be generated inside each terminal. In this case, each terminal is caused to wait for a period of time corresponding to the generated random number to start the updating operation.

In the updating operation started as the result of the user having been allowed to update the CERT information ST, the DVD recorder 11 first establishes a communication link with the proxy server 13 in the manufacturer M over the network N using the TCP/IP protocol in the network interface 21 (step S102).

After that, to transmit various commands including an authentication command to the proxy server 13 over the communication link, packets containing normal commands are produced and transmitted with conversion into capsule form through the capsule conversion unit 22 (process P01).

The authentication unit 23 makes device authentication through the proxy server 13 to the management server 14 using the same procedure as with device authentication to a device on a local area network (process P02/step S103).

A shared key that will be used by the decrypting unit 25 is generated between the DVD recorder 11 and the management server 14 through this process. At this point, the authentication unit 23 generates the shared key using CERT information ST (prior to updating) already stored in the storage unit 28 in the DVD recorder 11.

When device authentication to the management server 14 is normally terminated, the DVD recorder 11 requests the management server 14 via the proxy server 13 to transmit video data. The video data transmission request and the video data reception are carried out based on a protocol such as HTTP (Hyper-Text Transfer Protocol).

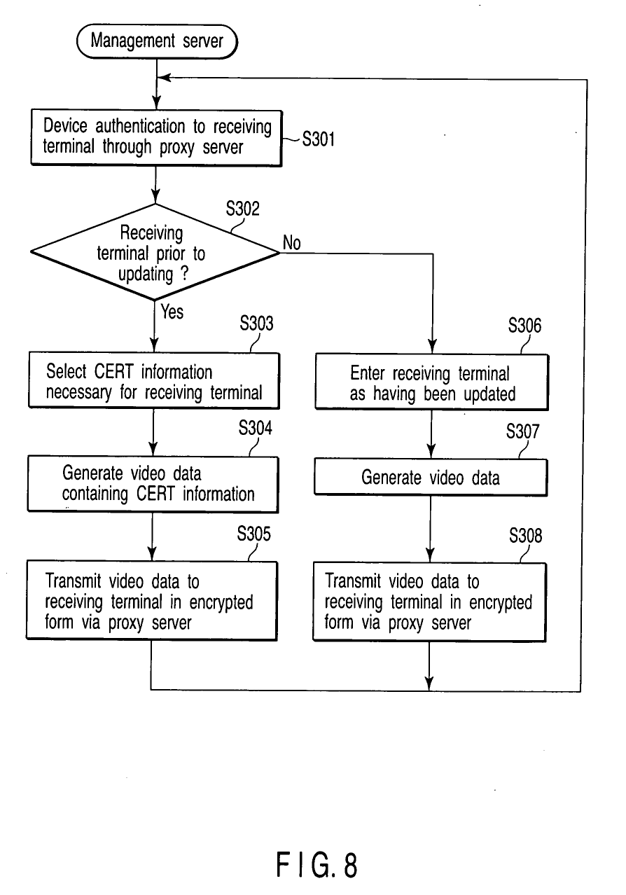

As shown in FIG. 8, after device authentication of the DVD recorder 11 by the authentication unit 44 (step S301), the management server 14 searches the storage unit 45 using the device ID of the DVD recorder 11 and the version information of CERT information obtained to make a decision of whether or not the CERT information ST is prior to updating, in other words, whether CERT information ST to be updated is present or absent (step S302).

If the decision is that the CERT information ST is prior to updating, differential information of the CERT information ST is selectively read from the storage unit 45 (step S303). Video data onto which the read differential information of the CERT information ST has been multiplexed is then generated in the video data processing unit 43 (step S304).

In this case, video and download data including differential information are multiplexed together using a table of program arrangement information to conform to digital broadcasting which adopts MPEG (Moving Picture coding Experts Group)-2 standards as extension specifications.

The differential information in the download data multiplexed cannot be utilized as CERT information ST in itself. Even if it is communicated over the network N including the Internet which is a public network, it is low in utility value for a third party. The management server 14 is thus allowed to hold data easily as it is low in utility value.

Next, the generated video data is encrypted in the encryption unit 42 using the shared key generated at the time of authentication of the DVD recorder 11 and then sent to the DVD recorder 11 via the proxy server 13 (process P03/step S305).

As shown in FIG. 6, when the video data is sent from the management server 14 as requested, the DVD recorder 11 receives it and then decrypts it in the decryption unit 25 using the generated shared key (step S104).

The decrypted video data is separated into the video data and the download data in the video data analysis unit 26.

The video data thus obtained indicates that the update operation is being performed. The video data is converted into a video signal in the notification/display unit 27. The resulting video signal is then displayed on the screen of the television monitor 12 to prompt the user of the DVD recorder 11 to be on standby (step S105).

The separated download data contains differential information from the latest CERT information ST at that point calculated through an operation of exclusive OR. The differential information is extracted (step S106) and then stored temporarily in the storage unit 28.

Next, the authentication unit 23 generates new CERT information ST from that differential information and the CERT information ST (prior to updating) already stored in the storage unit 28. To use it, the authentication unit 23 updates the CERT information tentatively (step S107).

The authentication unit 23 makes device authentication to the management server 14 again via the proxy server 13 as in step S103 (processes P04 and P05/step S108).

A shared key that will be used by the decoding unit 25 is generated anew between the DVD recorder 11 and the management server 14 through this process. At this point, the authentication unit 23 generates a shared key using new CERT information ST after updating stored in the storage unit 28 in the DVD recorder 11.

As shown in FIG. 8, after the authentication unit 44 has made device authentication between the management server 14 and the DVD recorder 11 (step S301), the management server 14 supposes that the device authentication has been normally terminated by decrypting an authentication command encrypted by the new CERT information ST and therefore determines at this point that the DVD recorder 11 has succeeded in updating the CERT information ST (step S302).

The management server 14 enters into the storage unit 45 that the DVD recorder 11 has updated the CERT information ST (step S306), then produces video data indicating that the CERT information ST has been updated successfully (step S307) and sends it in encrypted form to the DVD recorder 11 via the proxy server 13. (process P06/step S308).

As shown in FIG. 6, the DVD recorder 11 receives the video data from the management server 14 and decrypts it in the decryption unit 25 using the newly generated shared key (step S109).

The video data thus decrypted is then separated in the video data analysis unit 26 into video data and download data.

The video data thus obtained indicates that the CERT information ST has been updated successfully. When the video data can be decrypted, it is converted into a video signal in the notification/display unit 27. The video signal is then displayed on the television monitor 12 to notify the user of the DVD recorder 11 that the CERT information ST has been updated successfully (step S110).

The separated download data contains a control command to duly update the CERT information ST. To duly update the tentatively used CERT information ST, the CERT information ST stored in the storage unit 28 is overwritten (step S111). Thus, a series of operations of updating the CERT information ST in the DVD recorder 11 is complete.

If the DVD recorder 11 fails to decrypt the video data from the management server 14 in the decryption unit 25 within a set time, a retry is made. If the video data cannot be decrypted even when a predetermined number of retries has been made, the process is complete as updating having resulted in failure.

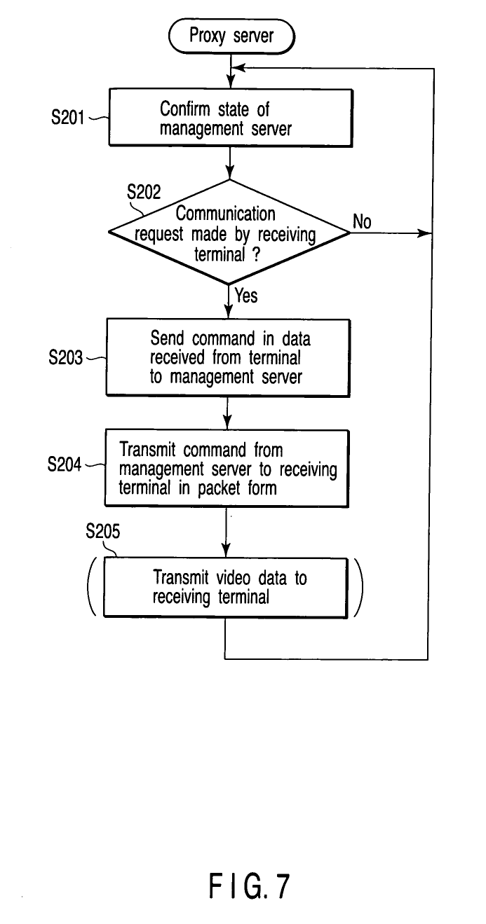

The proxy server 13 mediates between the DVD recorder 11 and the management server 14 for communication therebetween. As shown in FIG. 7, while continuously confirming the operating states of the management server 14 (step S201), the proxy server 13 decides whether or not there are requests for communication with the management server 14 from terminal devices including the DVD recorder 11 (step S202). The proxy server 13 carries out these steps repeatedly and accepts a communication request from a terminal device only when the management server 14 is able to make communication.

When the management server 14 is able to make communication and a communication request is made by the DVD recorder 11, the proxy server 13 extracts a payload portion from received data from the DVD recorder 11 in the capsule conversion unit 32, then takes a command out of the payload in the proxy authentication unit 33 and transfers it to the management server 14 (step S203).

In response to that command, the management server 14 issues a command, which is received by the proxy authentication unit 33 in the proxy server 13. The proxy authentication unit 33 sends the received command to the capsule conversion unit 32 where it is processed into packet data by being added with a header, then converted into capsule form and sent to the DVD recorder 11 (step S204).

An additional process is carried out when necessary. That is, the proxy server 13 sends a video data transmission request sent from the DVD recorder 11 after the process in step S204 has been performed several times to the management server 14, then obtains video data from the management server and transfers it to the DVD recorder 11 as it is (step S205).

By carrying out the processes in steps S201 through S205, the proxy server 13 mediates between the management server 11 and a large number of terminal devices including the DVD recorder 11 and prevents excessive load from being imposed on the management server 14.

As described above, since the copy protection scheme is applied to key updating in the DVD recorder 11, it is possible to confirm that the key has been updated correctly using copy protection. Thus, copy protection related secret information can be updated safely and easily without imposing a burden on users.

Thus, unique data of devices exemplified by DVD recorders can be updated using a public network such as the Internet.

In addition, distribution management of device unique data of terminal devices and confirmation of operations after updating can be performed at the same time, allowing the processing burden on the management server side to be alleviated.

Although, in the embodiment, the management server 14 which performs authentication and issues new CERT information ST and the proxy server 13 which mediates the management server 14 and the DVD recorder 11 have been described as being operated separately by the manufacturer M, this is not restrictive. The proxy server and the management server may be constructed integral with each other.

Naturally, the terminal device is not limited to a DVD recorder. The principles of the invention is applicable to any terminal device provided that it is configured as a digital household electrical product so that information for copy protection similar to CERT information can be updated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A household terminal device comprising:
first transmission means for, in updating signature information unique to the device which is used to cancel copy protection and provided from a networked external server, transmitting an authentication command added with the signature information already stored in order to share a first shared key with the server;
first reception means for receiving updated signature information encrypted using the first shared key which is transmitted from the server in response to the authentication command transmitted by the first transmission means;
second transmission means for transmitting an authentication command added with the updated signature information received by the first reception means in order to share a second shared key with the server;
second reception means for receiving information of updating completion encrypted with the second shared key which is transmitted from the server in response to the authentication command transmitted by the second transmission means;
decision means for decrypting the information received by the second reception means using the second shared key and then making a decision of whether or not updating has resulted in success depending on whether or not the information of updating completion has been decrypted successfully; and
update means for updating the signature information when the decision by the decision means is that updating has resulted in success.

2. The household terminal device according to claim 1, wherein the first reception means receives differential information between the signature information already stored and the updated signature information from the server, and the second transmission means creates updated signature information from the signature information already stored and the differential information and transmits the authentication command added with the created signature information.

3. The household terminal device according to claim 1, wherein the terminal device has a feature of receiving a video signal, and the first and second transmission means separate signature information and information of update completion which are multiplexed onto a video signal obtained by the video signal receiving feature from the video signal.

4. The household terminal device according to claim 1, wherein the first transmission means is started after a lapse of a length of time determined using a random number on the basis of a start command given by the server to update signature information.

5. A household terminal device updating method comprising:
a first transmission step for, in updating signature information unique to the device which is used to cancel copy protection and provided from a networked external server, transmitting an authentication command added with signature information already stored in order to create a first shared key shared with the server;
a first reception step for receiving updated signature information encrypted using the first shared key which is transmitted from the server in response to the authentication command transmitted in the first transmission step;
a second transmission step for transmitting an authentication command added with the updated signature information received in the first reception step in order to create a second shared key;
a second reception step for receiving information of updating completion encrypted with the second shared key which is transmitted from the server in response to the authentication command transmitted in the second transmission step;
a decision step for decrypting the information received in the second reception step using the second shared key and then making a decision of whether or not updating has resulted in success depending on whether or not the information of updating completion has been decrypted successfully; and
an update step for updating the signature information when the decision by the decision means is that updating has resulted in success.

6. A program which causes a computer to perform:
a first transmission step for, in updating signature information unique to the device which is used to cancel copy protection and provided from a networked external server, transmitting an authentication command added with signature information already stored in order to create a first shared key shared with the server;
a first reception step for receiving updated signature information encrypted using the first shared key which is transmitted from the server in response to the authentication command transmitted in the first transmission step;
a second transmission step for transmitting an authentication command added with the updated signature information received in the first reception step in order to create a second shared key;
a second reception step for receiving information of updating completion encrypted with the second shared key which is transmitted from the server in response to the authentication command transmitted in the second transmission step;
a decision step for decrypting the information received in the second reception step using the second shared key and then making a decision of whether or not updating has resulted in success depending on whether or not the information of updating completion has been decrypted successfully; and
an update step for updating the signature information when the decision by the decision means is that updating has resulted in success.
